(19) United States
(12) Patent Application Publication
(10) Pub. No.: US 2012/0110373 A1
(43) Pub. Date: May 3, 2012

(54) COMMUNICATION NETWORK AND METHOD FOR SAFETY-RELATED COMMUNICATION IN TUNNEL AND MINING STRUCTURES

(75) Inventor: Christoph Müller, Ladbergen (DE)

(73) Assignee: MINETRONICS GMBH, Hamburg (DE)

(21) Appl. No.: 13/380,922

(22) PCT Filed: May 18, 2010
(86) PCT No.: PCT/EP10/56825

§ 371 Date: Dec. 27, 2011

(30) Foreign Application Priority Data
Jun. 28, 2009 (DE) 10 2009 030 910.1

(51) Int. Cl. G06F 11/20

(52) U.S. Cl. 714/4.11; 714/E11.073

(57) ABSTRACT

A communication network in an underground system comprises a ring network computers which is connected to an aboveground central system computer unit, each computer having an overview of the overall structure of the ring network and an allocated network status. Plural network computers are configured to, in the event of a connection interruption between networked nodes, seek an alternative communication path in order to maintain the communications. Plural network computers are coupled to at least one sensor in order to pick up information relating to the environment and are configured to pass it on to other network computers of the ring network and/or to the aboveground central system. In normal operation, the network computers pass on current information relating to the environment to the aboveground central system and to other network computers. In a network island arising as a result of one or more connection interruptions, the network status of a multiplicity of the network computers changes from normal operation to emergency operation.

### TECHNICAL FIELD

The present invention relates to a communication network in an underground structure, wherein underground network computers are arranged at a number of nodes, which network computers are in each case connected to a central system computer unit in a normal case, wherein the network computers are configured to detect an emergency due to loss of the connection to the central system computer unit and then to initiate an emergency mode, and it also relates to a communication element for such a network and to a method for safety-related communication.

### PRIOR ART

Communication in the tunnel and mining sector takes place today with the aid of different system technologies. In this context, completely different systems such as, e.g., telephone, data lines (“bus systems”), safety systems for gas and fire alarm systems, or radio systems, are used for different purposes. All these systems must be installed and maintained separately which results in high operating costs.

It is the aim of the invention to unify the communication and by this means to achieve that the communication system can be amortized in daily operation. In addition, it should also serve for communication in an emergency at minimum additional costs and provide rescue teams with efficient communication with one another and with the operation controller. This saves the cost for installation and maintenance of a separate communication system only for applications of mine safety.

So-called “self-healing” ring networks are known, for example, from EP 0 545 932 and EP 0 591 429.

### DESCRIPTION OF THE INVENTION

On the basis of this prior art, the invention is based on the object of specifying a communication network by means of which mine safety is increased.

It is also an aim of the present invention to specify a method for operating a communication network by means of which mine safety can be supported in an emergency.

Finally, it is an aim of the present invention to specify an element for reliably restoring destroyed connection structures underground in a provisional manner.

A communication network according to the invention is characterized by the features of claim 1.

A communication network in an underground system comprises a ring network, arranged underground, of network computers which are connected to an aboveground central system computer unit, wherein each computer has an overview of the overall structure of the ring network and has one assigned network status. A multiplicity of these network computers is configured to seek an alternative communication path in the event of a connection interruption between network nodes in order to maintain the communication, wherein a multiplicity of the network computers is provided with or connected to at least one sensor in order to pick up information relating to the environment and is configured to pass on this information to other network computers of the ring network and/or to the aboveground central system. In this context, in normal operation, the network computers pass on current information relating to the environment to the aboveground central system and to other network computers. In a network island produced by one or more connection interruptions, said network status of a multiplicity of network computers changes from normal operation to emergency operation and one of said network computers having the emergency operation network status assumes a master status and all other network computers of the network island assume a slave status. Therefore, the network computer having the master status can provide said information relating to the environment to all other network computers of the network island in emergency operation and is also configured to take over network administration functions of the central system in the network island produced by the communication interruption.

A method for operating a communication network is characterized in claim 9.

An advantageous element for use with a communication network for setting up provisional connection structures is mentioned in claim 11.

The method according to the invention avoids the disadvantages of traditional communication and is based on the philosophy of utilizing uniform communication via Ethernet. In this unified system, all data and information items produced in the tunnel or mining industry are exchanged via network protocols such as, e.g., weather data (ventilation speed, temperatures, pressures), gas information (e.g. CO, CH4, etc.), operating data, machine information, control commands, video monitoring data, voice communication via PA (loudspeaker systems) or with stationary or mobile terminals (telephones), etc.

To divide the volume of data, various networks can be set up based on a single technology, each of them for its own purpose, e.g. in the form of utilizing different optical fibers in a cable strand or in the form of utilizing virtual networks (VLANs).

Important advantages of the technology lie in the usability of network-based redundancy technologies such as ring redundancy or meshing.

It is a core aspect of the invention, on the one hand, to utilize network information for safety purposes and, on the other hand, to utilize the active network components as active safety devices in tunnels and mines or other complex structures, ships etc.

In this context, utilization of a meshed network or one constructed in the form of a ring underground as a “sensor” for the integrity of the mine building is in the foreground in that, e.g., a sudden loss of connection provides information on possible accident locations.

In addition, the underground network acts as a dynamic, situation-dependent safety system. On the basis, e.g., of the information from the “sensor”, together with other safety-related information (e.g. gas or ventilation data), this creates dynamic rules of behavior for the colleagues located in the area of the “network islands” forming due to interruptions. For this purpose, the devices also utilize information, e.g. about the localities of emergency exits, fire extinguishers, rescue chambers etc. which have been downloaded to the individual network devices in normal operation. This information is then forwarded to the mobile devices of the colleagues either via displays on the device, via existing display devices such as PCs or TV monitors or by radio.

In this context, each of the network nodes underground has a logical map of the network and information regarding the statuses of the individual connections. The ring or multiple redundancy provides for high reliability. At the same time, each network node has access to environmental information (air speeds, gas measurements etc.) which are exchanged via the network.

If something unusual happens, (e.g. fire, tunnel collapse etc.), this is expressed by corresponding environmental sensors raising an alarm. However, these may be quite far apart and the location of the measurement is not the location of origin due to the ever present ventilation (air flow). Since the distances between the network nodes can be much less than the sensor distances, and since in the case of OWG lines, the distance from an interruption may also be measured directly, the failure of a network connection, together with the sensor information in the used air flow is used to obtain a possible location which can be used for two purposes: a.) on the side of the control center, for the initiation of mine rescue brigade actions (rescue forces); b.) underground for informing the staff and for generating dynamic evacuation and action procedures by means of the network nodes.

Active network components such as switches and access points normally only fulfill passive network functions, i.e. they are not an active component of any applications. The invention is based on the fact that in each active network component, a control unit, e.g. as an additional computer, is installed or locally allocated (or one of the CPUs already present in the switch or the access point is used), which makes the device into an active component of the applications, especially in regard to safety. In addition, these “network computers” can also handle other application functions (such as, e.g., tracking machines or persons).

The method consists of the following method sections:
1. Normal operation (there is no emergency)
2. Emergency with or without network connection to central systems—for self-rescue and central initiation of rescue measures
3. Network-based emergency support of rescue actions.

This is carried out by part-functions of the overall method which can be used individually or in combination:

The expert knows that the above second point of the initiation of rescue measures can come both from the side of the mine and from a centralized side outside the mine. In addition, both sides may be aware of the possibly still existing connections and thus coordinatable measures “behind” an accident point, that is to say an interruption.

### Network Redundancy Due to Rings and Meshing:

In the normal mode and in the emergency mode, the networks are structured in such a manner that a ring redundancy is produced. If, however, a ring is interrupted at two points, an island may be produced which can no longer be reached.

The ring redundancy can be further secured additionally by “cross connections” similar to a spider web (mesh) by means of an optional connection of devices with one another. This makes it possible to set up a network infrastructure which corresponds accurately to the structure of a tunnel system, mine or large block of buildings:

The prerequisite is only that a wire-connected or wireless network connection is possible between two active network nodes in each tunnel (or floor).

This enables the network always to look for alternative paths itself for maintaining communication if a connection should fail (“self-healing network”). This also automatically produces a map of the physical structure of the (underground) building via the instantaneous status of all network connections.

### Local Feeding-in of Environmental Data:

In the overall method, safety-related information such as data of the gas sensors or the weather sensor system (air speed, temperatures etc.) are fed into the local network directly at the location of origin. This can take place via direct connection of the sensors to the network computer, via sensor networks, via separate network-capable connecting devices or via the connection of a local weather computer.

The data of the sensor system are accessible to the nearest network computer. The latter may also preprocess the data and/or transform them into man-readable information (converting digital values into SI units etc.).

In normal operation, the network computer forwards the information to “aboveground” central systems.

In emergency operation, each network computer within an island provides its associated sensor information to all other network computers and possibly connected network clients locally via the network.

### Overview of the Network Status and Self-Monitoring:

Each active network computer has ideally a full overview of the overall structure of the network or at least within its local service area and thus has, itself or in coordination with its neighbors, the network status up to all relevant emergency exits and/or rescue means (shelters etc.). This status information about the active and available or unavailable network connections is exchanged permanently between the network computers in normal operation and in emergency mode. The term “full overview” advantageously means that the actual local position and the interconnections of all individual computers is present and that these data are interconnected with one another. This can be a database, the contents of which can be reproducibly represented on a display for human observers. In this case, “all individual computers” means logically interconnected “local computers” which means computers which belong to a connected complex of shafts, that is to say network computers via the physical location of which an emergency path may possibly physically lead. The information in such an overview can be regularly refreshed safety information, information on sites of emergency exits, rescue chambers etc. which, in an emergency mode, are displayed with priority and possibly automatically alternatingly.

In this context, e.g. every network computer permanently monitors the logical or physical connections to its “neighbors”. This can be carried out by purely logical techniques and control messages at IP level or also by interrogating the link status via the switch installed in the network computer or connected to the network computer. These enquiries are then preferably carried out via standardized methods such as, e.g., SNMP. The statuses are reported to the central station and/or to the accessible network computers in normal operation. This can be done, e.g., via broadcast messages. The lack of the message from a network computer then leads to an error status and the system may switch the network paths to an alternative path (see above).

These status messages can also contain the environmental data assigned to the network computer and information about the device itself (such as, e.g., the battery status). This results in self-monitoring of the network which is of great significance in an emergency mode. In normal operation, too, this is important, e.g., for the maintenance and repair of the network.

Each network computer also has the corresponding information about rescue paths and safety equipment which is loaded from a central server, e.g. during boot-up, and is then stored permanently in the network computer and updated in the case of changes so that it is accessible in a current form in an emergency and also when the connection to the corresponding central system (server) is interrupted. This information present in the network computer provides important functions for the evacuation and correct action in an emergency for the persons within the emergency area. These are described in the following sections:

### Splitting Up the Networks in Emergency Mode:

In an emergency, it can be assumed that the connection of the underground network to the central facilities, e.g. above ground or in a control center, is interrupted even if it is redundantly constructed. In such a case, one—or even more—network islands are produced which then remain wholly or partially operable. Such an island can consist of one or more active network computers.

The emergency mode is recognized by the active network computers in the still operable island (or islands) due to the fact that there is no longer any connection to the central systems.

In this case, the network computers switch to an emergency mode in which they themselves attempt within certain time intervals to set up contact to the no longer existing “neighbors” in order to make the island larger and possibly be able to recognize when contact to the central systems is restored.

In the emergency mode, a network computer in an island takes over the network administration functions of the central system, which are of importance in an emergency, such as, e.g.:
issuing the network addresses to safety-related devices such as (mobile) telephones, safety-related sensor systems and the like via a DHCP server, to be activated in an emergency mode;
activating an SIP server as the central device for setting up voice communication within the “island”.

The question as to which network computer will handle these additional administrative functions will be negotiated, e.g., randomly among the network computers. This can be done, e.g., in that a network computer which is the first one to recognize the failure informs, by sending out a broadcast message, all others in the island that it has itself taken over the central network administration functions. As an alternative, the computer in the center of the island can also always take over the central functions or determine which one of its neighbors has to take over which central function. In this context, the network computer which is the farthest away from all end points of the network will become master. From a safety point of view, this is most meaningful because this largely eliminates the possibility that this computer will be close to a danger point.

The calculations for determining the master computer can also include the battery status of the network computers which prevents a computer having a low battery capacitance from being named master. All other computers will thus in each case automatically become a slave.

These method features contain advantageous embodiments of the invention to the effect that the display of the respective local computer indicates the current most advantageous path out of the hazardous situation which is recognizable for the network, wherein this can be a path to the outside or else into a protective space or a room of the underground area graded to be safe.

If two independent islands are connected together (e.g. because a connection is restored between two islands), the network computer of the island having the larger number of active terminals (“clients”) takes over the central functions for the newly created larger area. The central device in the formerly smaller island terminates its central functions.

### Recognition of the Instantaneous Situation in an Emergency:

By means of the current information about the network status and the current environmental information, each network computer within an island can obtain a picture of the complete safety situation even without a connection to a central system. In particular, this relates to the location of emergency exits and the path there and to the status of the paths to the emergency exits. In this context, an existing network connection is preferably interpreted as “this path is presumably usable for an evacuation”, wherein existing environmental sensors can point to sources of danger such as poisonous gas concentrations or water penetration.

This information is forwarded to the persons using the method steps represented in the text which follows. By means of the basic information about the localities, also present on the network computers, information, e.g. about the length of routes and the position of other rescue means (oxygen, rescue masks, stretchers, fire extinguishers etc.) can thus also be made available. In particular, the computer can create safety information from the available information and display this visually or audibly itself on a display or forward this safety information via network/WLAN to other stationary or mobile subscribers.

### Dynamic Evacuation Aid:

If network cables are lying in all tunnels or floors, it is possible also to recognize via the status existing in the network computer whether rescue paths are free or blocked. If a network computer recognizes that a connection between two network computers is interrupted, this can be interpreted (possibly by also using other information such as, e.g. “air speed in this tunnel or floor is equal to zero” or “air temperature in this area (at a network computer) was or is very high”) as indicating that this path is not available for evacuating persons. The network computer can forward this situation to the persons underground or in the building even without connection to central devices. This is preferably carried out by means of the following method steps:
1. A processing unit in a network computer or in the central system interprets the values of the environmental sensors and the statuses of the connections to adjacent computers and recognizes, e.g., the positive/negative transgression of safety-related threshold values apparent from tables or functions. From this, one or more output signals are derived which point to escape routes or escape rooms and/or which are suitable for displaying such routes or rooms on connected display units or which point to the presumable blocking of a possible escape route (e.g. due to the presence of very high temperatures and/or CO measured values).
2. The presumable nonavailability of the escape route is supported by the temporal relationship with a break in the network connection to an adjacent network computer.
3. The processing unit generates a predefined data message which can be obtained and possibly interpreted by all subscribers in the network. This message contains at least the position information of the sensor and/or connection signals included in the processing and the corresponding sensor value and/or the consequences to be drawn from this sensor value such as “it is presumably burning here” or “this path is presumably not available for an evacuation”.
4. The processing unit sends the message to all subscribers in the network (by broadcast message) or only to those subscribers who are explicitly intended to receive these messages.
5. A processing unit in the receiving devices interprets the messages and displays them on a display or switches notice boards or light signals correspondingly so that the colleagues can be guided in an alternative direction (see descriptions below such as, e.g., beacon function, display or mobile terminals).

If there is still a connection to the central systems, corresponding behavioral instructions can naturally also be downloaded dynamically from the central devices to the network computers. This information can be forwarded by all network computers in the corresponding island to the persons who are located within its range. This is done, e.g., via the method steps represented in the following points:

### Securing the Complete Evacuation

If all persons carry corresponding tags (transponders) and if the network computers are equipped with the associated readers, the method is capable of recognizing the complete evacuation of an area and thus ensuring that there are no more persons in the area “behind” a network node. This method step proceeds in the following stages:
1. In normal operation, each network computer recognizes the transponders in its vicinity via the transponder reader or via WLAN.
2. The network computer forwards this information to a central system.
3. At the same time, the network computer stores the person-related movement information with transponder No. and time stamp over a period of at least one shift in a separate installed memory.
4. An emergency occurs and the connections to the central system are lost.
5. Due to the movement information stored according to 3., all network computers in an island “know” which persons must be located within the island:
   1. Persons whose transponders are still actively visible in the network.
   2. Persons whose transponders are not actively visible in the network but were located in an area between two network computers which is not covered at the time of the initiation of the emergency mode. These were recognized by one or more network computers and due to the temporal sequence of the reading events it is possible to determine that they are still located in the area. This also applies to persons who were detected once in a “blind alley” by the last network computer, e.g. at the entrance to the route, but have not yet been recognized a second time on leaving.
6. A master computer determines the best meeting point for all persons located in the area so that they can either come to the assembly point (assembly station) with a shortest possible route or meet at a rescue point (rescue chamber or the like). Since a completely computer-oriented decision does not necessarily correspond to the situation, persons on site who have, e.g., a PDA or a network PC, can also intervene in the determination of this assembly point.
7. The persons are guided to the assembly point (e.g. via the “beacon function”) or displays and dynamic emergency signs via the network computers. In this context, the persons should only proceed when the network computers signal to them (e.g. by changing colors of the beacon function) that there are no longer any persons in the area “behind” them. The absence of black arrows in FIG. 4 signals areas free of persons in a partially evacuated network island whereas in the case of the other black arrows, there are still persons “behind” the network computers. The grey arrow indicates the probable best escape route.

The utilization of transponder information which may occur on other wavelengths than the network communication allows the evacuation situation to be mapped and includes an advantageous embodiment of the invention.

### Beacon Function of the Active Network Components:

A flashing LED on a network computer signals the path to a rescue means such as to a shelter or to an open emergency exit. This can apply both to normal operation and to emergency operation. These “beacon functions” can be configured, for example, in such a manner that the messages following are conveyed by means of colored flashes or by means of blinking signals. Color coding could be structured as follows:
Green: This network computer has a connection to a device which has network contact to an emergency exit or a rescue means;
Red: Danger of gases hazardous to health within range of the network computer;
Blue: The network computer has a connection to a device which has network contact to an emergency exit or to a rescue means. At the same time, there is a gas hazard on this path (“use rescue masks”);
White: No information about emergency exits or rescue means available. The network computer is operational.

Other color codes or flashing signals can serve to indicate areas free of persons or to signal that there are still persons in the area “behind” the network computer (see above).

Details about the respective statuses may possibly be called up by button pressing via a display (see above) or wirelessly via PDAs or mobile telephones (see below).

### Display for Emergency and Staff Information:

In the network computer, a display can be installed (or connected to it) which displays permanently or only on button pressing safety notices or staff information. Such information can be, e.g.: dynamic emergency exit information; depending on the network information about the status of escape routes, the direction of an escape route is indicated dynamically. This can be done in the form of a standard symbol for “emergency exit”. This standard arrow may then change the direction in dependence on the current status of the escape routes and thus always points in the direction of a presumably available emergency exit and thus offers a considerable advantage compared with the static symbols which can always point only statically in the direction of the nearest emergency exit even though it could be blocked in dependence on the situation.

The display can be activated by button pressing in order to extend the battery life in an emergency in the case of battery operation. The LED (see above) thus points the way to a device and detailed information is available via the display by button pressing.

The entire situation can then also be displayed, for example graphically, on the display, wherein the paths to emergency exits and the positions of emergency equipment can be displayed in a schematic graphic or in a 3D image true to scale. Similarly, additional information can be input, for example, by button pressing or touch screen and displayed to all persons such as, e.g., “the emergency exit indicated as blocked is still available (or has been made available by us) etc. This information is then distributed in the network and influences the representation of the image of the situation. This can also contain the localities of persons in the mine image (see above).

### Forwarding Information to Mobile Terminals:

Since the network computers can have WLAN access points or can have network contact to those, the relevant information can also be made accessible to mobile terminals in an emergency.

This can be carried out by means of the following method steps:
1. In normal operation, the mobile terminals receive their information, e.g. about the environmental data such as values of gas sensors or information on the velocity of air from central servers.
2. Since the sensor information is fed locally into the safety-related network, it becomes accessible to the user of mobile terminals.
3. Each network computer or a central network computer in an island provides this information to the mobile terminals. This is carried out, e.g., via web technologies such as web browsers or JAVA applications, by XML datagrams, by SMS-like methods or via datagrams defined especially for this purpose.

### Loudspeaker Functions of the Network Computers and Mobile Terminals:

Each network computer can have a voice terminal which consists of loudspeaker and microphone and possibly additional keys. This can be installed in the network computer or connected separately to it or to the network.

In normal operation, these voice terminals are used for communicating with the staff, e.g. for general announcements (PA=public address system) for information purposes or as local warning, e.g. against approaching mobile machines. In this context, the latter can also be generated automatically by the network computer if, e.g., a machine is moving into the wireless range of a network computer, it and the next network computer in the chain warns against the approaching machine via a sound signal similar to an approach warning or via an automatically played voice announcement.

In emergency operation, the voice terminals are used for communication with the persons who are located in a network island or with a central station if there is still a connection. In this context, all voice terminals are preferably joined to form a single group in emergency mode so that all persons in the island can listen to all conversations. This joining preferably includes also the mobile terminals capable of voice communication and stationary telephones so that communication with all other persons in the area is also possible from these devices.

The central functions of the voice communication (SIP server) are handled by the central device which coordinates the administrative network functions, or by another network computer in an island if there is no (longer) connection to a central system.

### Power Shutdown Unit:

In the case of potentially hazardous gas concentrations, power supply components must be shut down—possibly over a long distance. For this purpose, assemblies which are connected to the power switchgear via the network can be connected to the network computer. In this context, the environmental information is also used which has been determined by the sensor system allocated to a network computer.

The detection of the sensor information or the derivation of safety-critical and shutdown-related statuses can be carried out by the network computer directly by software if this is permissible from a safety point of view. Otherwise, an external sensor unit handles this task and the network computer provides a safety-related communication to the shutdown unit.

The shutdown unit is traditionally connected either to a (remote) network computer or installed in the latter or attached directly to a power switchgear or installed in the latter.

Detection and shutdown unit are permanently in direct network contact with one another and exchange messages about the safety status. These messages contain sequence and timestamp information and also authenticity information. Their contents are preferably protected by encryption against misuse. If the network connection is interrupted, the messages fail to appear and an immediate shutdown occurs for safety reasons. The same occurs in the case of inconsistent messages or if they signal a shutdown-related sensor information.

The power shutdown relates especially to medium voltages for supplying the mine with power in productive application. The network elements which are used in accordance with the invention or used by the method according to the invention are provided, on the one hand, with housings protected against, e.g., arcing and have either an also battery-supported voltage supply for emergencies.

### Warnings to the Staff:

A network computer can trigger directly, or via a peripheral device connected or arranged in the network, e.g. triggered by the position information of persons and machines in the network, audiovisual warnings if, e.g., machines or vehicles approach the area or other possible dangers are detected via sensors or via data messages from the network. Such data messages can also be generated, e.g., by a colleague dialing one or more devices via certain telephone numbers and himself announcing a message or by this means triggering the playing of a prepared message via loudspeaker system and/or display. This can also be carried out, e.g., by sending out text messages which are generated manually by persons or automatically (e.g. by traveling machines).

### Support of Rescue Actions:

At each network computer or at additional devices within the network, rescue equipment can also be optionally connected which is utilized by rescue teams such as, e.g., fire department or mine rescue brigade. This enables these rescue teams also to use still functioning parts of the network for their work and to set up better communication between the rescue team on site and operation control. This communication can then also contain, e.g., multimedia information from mobile cameras.

The following functions, in particular, are used for connecting rescue equipment:
1. Connections for voice communication devices;
2. Connections for traditional rescue communication systems;
3. Connections/interfaces for radio systems as used, e.g., by fire department or police;
4. Connections for semimobile network components for setting up temporary networks, especially for rescue teams.

### Connections for Voice and Rescue Communication:

At the voice terminals or network computers, connections for voice combinations can also be optionally present which are installed, e.g., into rescue masks or full protection suits. This also provides for communication when persons must communicate with one another under respiratory protection conditions and for rescue teams between one another and when rescue teams attempt to establish contact to other persons in the area, e.g. by utilizing the loudspeaker functions.

In addition, there can be connections for traditional communication lines as are used today already by rescue teams, e.g. in mines, such as, e.g. pricher lines.

### Connections for Traditional Radio Systems:

In the safety-oriented underground network, interface devices can also be present which connect the VoIP-based voice communication of the network to the radio system, e.g. of the fire department. Since the range of the radio devices is limited underground, the rescue teams can communicate by this means even over a greater range because parts of the radio link are passed in digital form via the network (e.g. by VoIP). On the other hand, direct communication of the rescue radio devices with persons in the network is possible, e.g. via the voice terminals. These devices are either installed in a network computer or connected to any point in the network. They can be installed permanently in the network or are attached temporarily in the network during an operation.

### Semimobile Network Units for Temporary Operations and Rescue Teams:

In rescue operations, it will happen that these occur in areas in which it can no longer be expected that the network is operable.

At the same time, the network computers of still operable network islands contain stored information which can contain important information for incoming mine rescue teams such as, e.g., the information that a complete area has been left by persons since no further transponders are detected in this area. Search actions can thus concentrate primarily on other areas. In order to enable the rescue teams to be connected to underground network islands, restore temporary connections between network islands and an operable external network and facilitate the work via a permanent network communication and make it more reliable and thus also provide for the transmission of image and video information from the rescue location to operation control, mobile units are used which are taken along by the rescue teams. Such a mobile unit consists of a cable drum with a rolled-up industrial optical waveguide cable or with a copper-based network cable (FIG. 4).

Into the core of the drum, the electronics of a network computer and of an access point and of a switch are installed. A battery pack can either be installed and/or connected in a mobile manner. It is also possible to supply power via a hybrid cable which contains both OWG and a supply line.

The network cable of the drum is connected to an operable switch or a network computer and rolled out.

At the end of the cable, the cable drum is deposited or hung up. Power supply and antennas and possibly other peripheral devices are connected to the terminals in the core of the cable drum. Due to the installed access point, wireless communication is also possible in the environment of the drum. This is needed for, e.g., wireless voice communication devices, wireless sensor units for environmental measurements, cameras or devices which monitor the vital data of the persons of the rescue team and forward them to operation control so that these persons do not have to be unnecessarily exposed to health risks.

In addition, other electronic devices which are of assistance or required for rescue operations such as, e.g., environmental measuring instruments or converters for non-Ethernet-based radio devices, can be installed in the core of the cable drum. Processing of the corresponding data can then be handled by the processing unit of the installed network computer.

The cable drum, as an element of a communication network, can also be used in other networks to be installed provisionally such as in provisional LANs or where mobile communication must be based on provisional microtransmitters.

The next cable drum is then connected to the network terminals of the switch in each cable drum. By this means, a completely separate and mobile network can be built up even over relatively long distances. The drums can also be used for temporarily restoring defective network sections of the permanently installed network into operation in order to find out, for example, whether there are still persons located in the island thus reconnected.

This also provides the rescue teams with the possibility of interrogating via the connection to the stationary network computers which mobile devices are currently located in the area or which were located in this area when the emergency mode was initiated.

### Initializing the Method:

If a new intelligent network computer is included into a system or if an intelligent network computer is “transferred” (relocated) to another point in the system, an automatic method is run in which the network computer is initialized. The latter stores all information items in its own read-only memory so that these continue to be available even after a break in the connection to the central systems.
1. First initialization at a location at which there has previously not been a device:
   1.1. The device registers with the central system or looks actively for such a central system or is found automatically by the central system.
   1.2. A user enters the locality (position) of the system in the corresponding mine coordinates on the central system after authorization.
   1.3. The user may set further administrative initialization values.
   1.4. The device thus knows its position. It now proceeds as described for the relocation of the device (from step . . . ).
2. Relocation of a device which has already been initialized first to another position:
   2.1. The device registers with the central system after switch-on and connection to the network.
   2.2. The central system determines that, instead of a device located earlier at this logical point in the network, another hardware has been installed.
   2.3. The central system asks a user whether the device has been installed as direct replacement at an identical position as the old system. If yes, the method continues immediately with step 4. If no, steps 2 and 3 are processed from the first initialization before step 4 is processed.
   2.4. The network computer asks its “neighbors” for their positions and the connections to other devices and, using this, builds up its own network model. This is permanently stored in read-only memory. As an alternative, this information can also be downloaded from the central system to the network computer.
   2.5. The central system downloads either the associated infrastructures (length of network connections and thus of the tunnel route lengths) between the network computers to the network computer. These link the information to their logical network data and thus know the distances between the individual network computers. As an alternative, the network computer can enquire these data also from the central system (or at a “neighbor” already installed). The latter avoids unnecessary data transfer over the entire network.
   2.6. In addition, the positions of emergency exits and rescue equipment are also downloaded from the central system or from the neighbor.
   2.7. Furthermore, special coordinates and position-dependent applications can also be downloaded from central systems which provide the device with special tasks which are dependent, e.g., on the position of the device, such as playing of certain text warnings via the loudspeaker system or switching on the display when people pass in the vicinity or when vehicles or machines are approaching.
   2.8. The device goes into normal operation and can fulfill the method-related tasks.

The systems are thus prepared for their local tasks for supporting the mine safety. As an alternative, the configuration can also be carried out manually, e.g. via web browsers.

### Safety Trip Recorder:

In emergency mode, the device writes all safety-related data into a trip recorder which is installed in the read-only memory. By this means, data can be read out possibly subsequently about the behavior of persons and machines, their positions etc.

### System:

The system consists of a computer, the connected local peripherals and the network connections between the local units and central systems.

In normal operation, the overall system represents a self-contained unit which per se facilitates the mining operation and optimizes the resources used for investment, installation, operation and maintenance by unifying the communication. At the same time, the system, due to Ethernet, is open for permitting future devices and systems to be coupled to it.

The entire system consists of a number of intelligent network computers underground which, together with their associated peripherals represent the core of the functionality. These implement the method explained above.

The necessary peripherals can be installed directly in the device or connected directly to the device via various interfaces or be connected via the network.

It is only of importance to the method that the network computers underground handle the local processing of information so that they can forward it to the staff in normal or emergency operation. In this context, it is of no importance whether a network connection to the central systems is present or not.

Further exemplary embodiments are described in the dependent claims.

### BRIEF DESCRIPTION OF THE DRAWINGS

In the text which follows, preferred embodiments of the invention will be described with reference to the drawings which are only used for explanation and should not be interpreted to be restrictive. In the drawings:

FIGS. 1A & B show a diagrammatic representation of a ring network in normal operation and in the case of a disturbance;

FIGS. 2A & B show a diagrammatic representation of a meshed ring network in normal operation and in the case of a disturbance;

FIG. 3 shows a diagrammatic representation of a mine region cut off by network interruptions, with symbolic indicators at the network computers (arrows) for the dynamic evacuation and for indicating whether part-regions have been evacuated or not; and

FIG. 4 shows a diagrammatic representation of the side of a cable drum comprising a network node, installed in the core of the cable drum with OWG or hybrid cable, with OWG terminals and radio access, power supply and additional peripheral terminals 4) for the temporary connection of networks by rescue forces or for setting up independent temporary networks for rescue actions.

### DESCRIPTION OF PREFERRED EMBODIMENTS

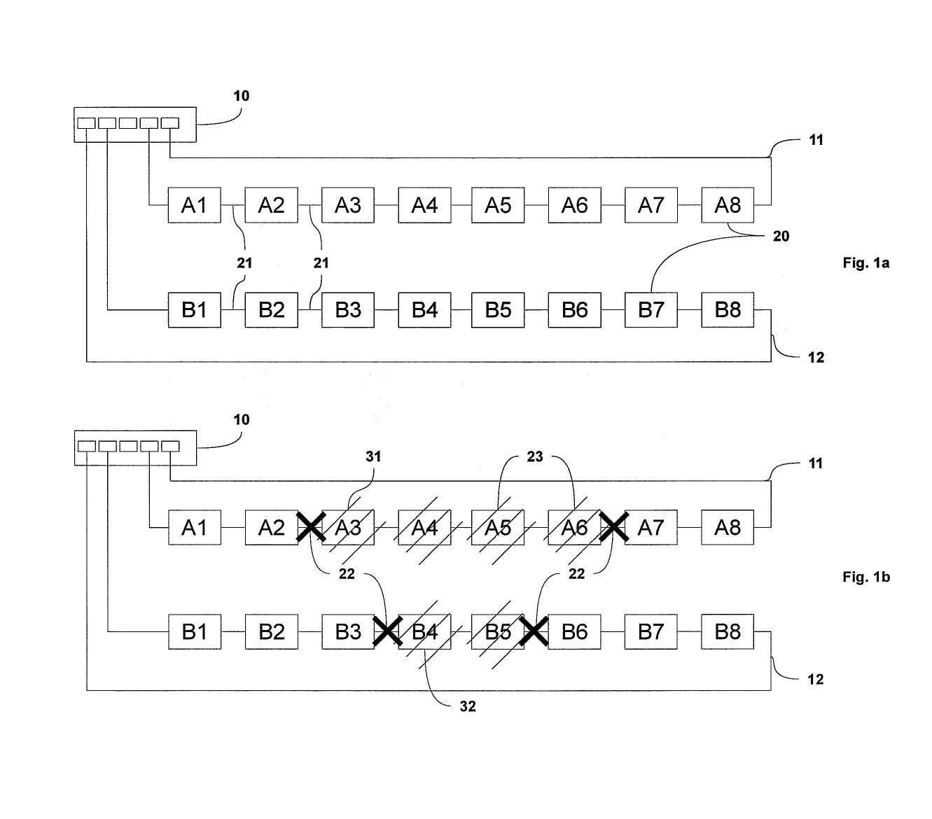

FIG. 1A shows an example of a network in a diagrammatic representation as ring network in normal operation and in the case of a disturbance.

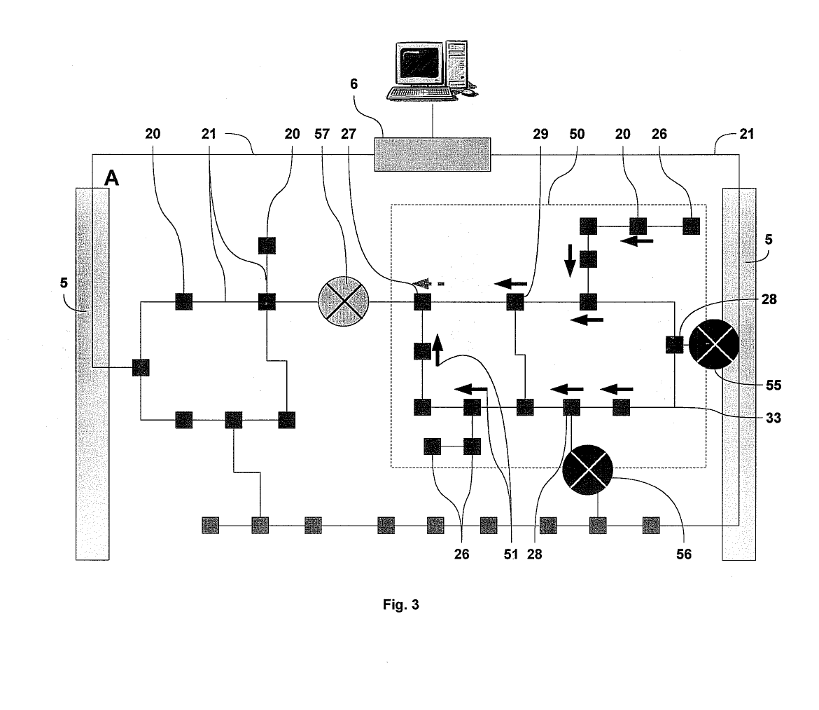

The switch 10 is shown as a symbolic image of the network architecture arranged outside the underground system. There are two independent underground rings 11 and 12 which have a ring structure. Each ring in this case has, for example, eight network units A1 to A8 and B1 to B8, respectively, which are generically designated as computers 20. Naturally, this number can be greater or less and the connections 21 between two units can be several 100 meters tunnel length or a few meters in distance. The connections 21 can also be radio links. Each computer 20 can comprise sensors for picking up environmental data such as temperature, gas concentrations etc. Computers can have unmissable external display elements for sending out optical warnings and corresponding loudspeakers. There can be interfaces (cables or, e.g. Bluetooth) to sensors and to external headsets. Furthermore, network interfaces are provided and an input unit such as a keyboard and a display, especially for displaying information relating to, for example, the sites of rescue means, the status of the dynamic evacuation and area free messages (see description for FIG. 3) etc.

FIG. 1B then shows a case of failure where the connections 21 are broken or destroyed at several points 22. The computers 23 shown shaded are thus isolated and no longer connected to the rest of the network. They can be called island computers 23. These form islands 31 and 32. The computers in 23 then enter an emergency mode, wherein one of the computers of each island A3 to A6 and B4 and B5, respectively, assumes a master status in accordance with the description.

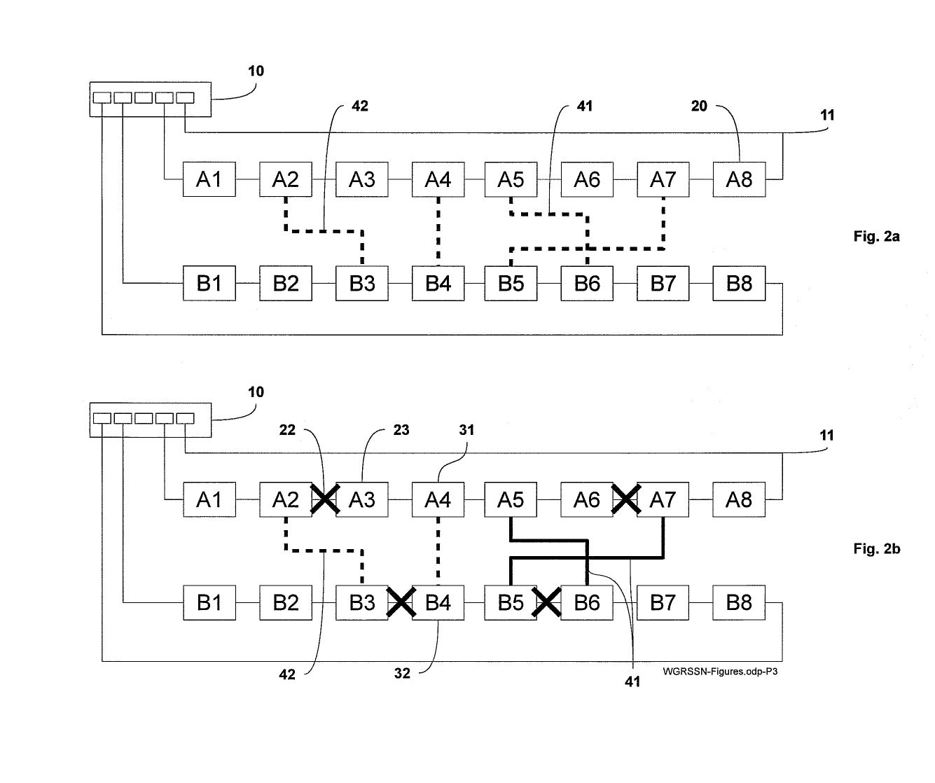

FIG. 2A shows a ring according to FIG. 1A with wire-connected or wireless cross connections 41, 42 which are arranged according to mine-related aspects. When a failure case as in FIG. 1B occurs, the connections 42 are activated whereas the connections 42 still remain optionally unconnected. Searching for the (either wireless or wire-connected) connections 41, which allows computers of the islands 31 and 32 to be reconnected, is one of the functions of the islands in emergency operation, and of the respective master computers.

All identical or similar features are provided with the same reference symbols in all drawings.

The individual network computers are preferably connected to one another in rings or meshed rings in order to ensure the greatest possible reliability of communication. Ideally, a network cable is located in each tunnel section, by which means then an entire mine is logically covered and the network redundancy corresponds precisely to the redundancy of the escape routes in a mine.

This avoids the disadvantage of the conventional ring network in which unreachable islands occur as soon as two connections or active components fail.

If these rings are meshed with one another, the islands otherwise cut off remain accessible with a much higher probability.

These switch-overs are performed automatically by the network computers when necessary. Inactive network lines are monitored permanently by the two network computers connected.

The communication network in an underground system comprises a ring network of individual network computers, arranged underground. At least one, preferably a number of network computers are connected to an aboveground central system computer unit via various lines. In this context, a line is understood to be a cable-based Ethernet line, a corresponding coaxial line, an optical waveguide line or cableless radio links (WiFi, WLAN). Each computer has here an overview of the entire structure of the ring network and an assigned network status. Overview of the entire structure is understood to be the network structure according to FIG. 3 and also the infrastructure of the underground structure itself such as the distribution of safety-related locations and objects such as emergency shelters, fire extinguishers, emergency exit information etc. This also includes room climate data and interrogation possibilities or display possibilities for temperatures, gas concentrations etc. The network status corresponds to the capabilities of the device. In such a structure, there can be more significant computers and smaller computer units. A part of the status information is the variable status information of normal operation or emergency operation. Invariable status information is the information whether the computer is capable of handling network-administration tasks and whether it has taken them over. The trigger for a change of the status is when a threshold value is exceeded (such as, for example, gas concentration measurement values of a sensor, temperature measurement values of a sensor of the computer) or a triggering signal (break in the connection to one of a group of certain other network computers; arrival of an emergency signal from another computer of the network or a mobile device of a colleague), etc. Apart from the coarse grading of normal operation and emergency operation, intermediate stages such as local failure mode can also be defined.

A multiplicity of the network computers is configured to seek an alternative communication path in the event of a connection interruption between network nodes in order to maintain communication; not all of them must be capable of doing this.

A multiplicity of the network computers is provided with or connected directly or via the network to at least one sensor in order to pick up information relating to the environment and is configured to pass on this information to other network computers of the ring network and/or to the aboveground central system. This relates to said temperatures; gas concentrations; air movements and ventilation information etc., wherein, in normal operation, the network computers pass on such current information relating to the environment to the aboveground central system and to other network computers.

When the network structure is damaged due to one or more interruptions, so-called network islands are produced. In the case of a multiplicity of the network computers, the possibility exists to detect such a fault (=loss for routing information to the aboveground central computer) and said network status is then changed from normal operation to emergency operation in the network island produced in this manner by one or more connection interruptions. The emergency operation can also be triggered manually by an authorized user or—if still connected—e.g. by the central system.

These computers then also report this status to the computers not equipped for this purpose. One of said network computers having the emergency operation network status then assumes a master status and informs all other network computers of the network island that they should assume a slave status. Various features can be determining for the selection of the master computer. It can be one of the faster computers of the network islands, the first computer which detects this circumstance, the central computer in the node of the island formed; etc. It is also configured for taking over network-administration functions of the central system in the network island produced by the connection interruption.

This network computer having the master status then receives said information relating to the environment in emergency operation and informs all other network computers of the network island of this. As an alternative, all computers in the network island determine the status of the sensors allocated to them and report these to all network participants, e.g. by broadcast message. By this means, the at least one computer can point dynamically to shelters, escape routes, hazards from environmental conditions etc. in interaction with the information still available in the island. This can then be done by every slave computer. The negotiable information may also include telephony connections via Ethernet cable (VoIP), on the one hand as telephony operation or also as broadcast so that all persons concerned in such a network island can communicate with all other affected persons, the number of whom they may not need to know; the location of people and material from registered hand-held sets which is recorded so that it can be read out later.

In the case of another advantageous embodiment, it is not only the master computer which processes this environmental information. This processing can also be carried out distributed by the computers of the network to which the sensors are connected. This will also be the case preferably because in this way, relatively small network islands also have the advantage of the combination and processing of the environmental information at one location.

Another function is the attempt of self-healing of the network by searching for alternative routing connections 41, 42 to the central computer above ground as shown in FIG. 2B. On the one hand, active ping signals are sent to the known fixed addresses but also by broadcast in order to establish a connection to mobile units which, for example, are brought into the underground system by rescue forces, which then establish the connection to the aboveground network.

FIG. 3 shows a diagrammatic representation of a mine region 50 cut off by network interruptions, with symbolic indicators at the network computers (arrows 51) for the dynamic evacuation and for indicating whether part-regions have been evacuated or not. The mine is represented by two shafts 5. Above ground, the network system 6 is represented by a basic circuit diagram. The connections 21 extend through the shafts 5 into one or more galleries, a basic circuit diagram of which is shown here in FIG. 3. The computers 20 and the connections 21 are ultimately underground a diagrammatic representation of the galleries of a particular level. Meshing connections 41 and 42 can comprise, for example, exactly one connection between two levels, that is to say two gallery systems at different depth level. Computers 20 in an area 50 are cut off from the aboveground network 6 by three interruption points 55, 56 and 57. A computer island 33 without connection to the outside is produced.

The computers 20 of the island organize themselves under a master computer 29 to which various ones of the criteria mentioned here apply as cumulatively as possible and in accordance with weighting. In this case, it is a computer 29 of sufficient capacity having adequate battery protection in the center of the cut-off island. By means of sensor information from computers 27 and 28, particularly relating to temperature, gas and dust concentration and possibly predetermined parameters, the master computer decides that the most reasonable escape route goes in the direction of computer 27 and an exit via the break point 57 promises to be most successful. Computers 27 and 28 can be called edge computers with respect to the existing island. For this reason, an arrow symbol 51 is displayed on all computers with a corresponding indication as to the direction in which mine workers should go who appear with a corresponding indication at one of the computers 20. At the same time, it can be indicated whether persons are still detected with a locating device/transponder in an area “behind” the arrow. This is not the case at computers 26 with “empty area” so that the master computer 29 assumes that these mine areas are already deserted and thus do not have the first priority in the inspection by rescue forces. The path of arrows 51 in the direction of the interruption 57 indicates the path most suitable for an evacuation.

FIG. 4 shows a diagrammatic representation of the side of a cable drum 100 comprising a network node, built into the core 101 of the cable drum 100 with OWG or hybrid cable, comprising optical waveguide (OWG) terminals 103 and radio access 102, power supply 107 and additional peripheral terminals 104 for the temporary connection of networks by rescue forces or for setting up independent temporary networks for rescue actions. This provides rescue teams with the connection to underground network islands 50 since temporary connections between network islands 50 and an operable external network 6 are restored. An industrial optical waveguide cable 105 or copper-based network cable are rolled onto the cable drum 100. One end of the cable 105 can be inserted into a network computer 20 connected to the outside computer after which the users of the cable drum 100 then roll it out in accordance with its progress. At an appropriate point of use or at the end of the cable route 105, the drum 100 is placed down or set up, for example via a rack at the hub 106, in order to connect further components. The other end of the cable 105 is preferably connected or spliced on already from the beginning by means of a corresponding inside connector/socket of the cable drum. Elements 102, 103 and 104 are thus directly operational, especially if a power supply 107 is connected. As an alternative, a voltage supply can also be integrated in the drum 100. The next drum 100 can then be connected to the OWG interfaces or Ethernet interfaces 103 or, if an interruption point 57 is overcome, the network island 50 can be connected.

In the core 101 of the drum 100, the electronics of a network computer (as it were, a computer having the capabilities of a slave computer 20) and of an access point and of a switch are also preferably installed. A battery pack can either be installed and/or connected in mobile manner. A power supply via a hybrid cable is also possible which contains both OWG and a supply line. The network cable of the drum is connected to an operable switch or a network computer and rolled out. The drum of FIG. 4 can also be used without using a method according to FIG. 3.

LIST OF REFERENCE DESIGNATIONS

| | |
|---|---|
| 5 | Shaft |
| 6 | Network system |
| 10 | Switch |
| 11, 12 | Underground ring |
| 20 | Computer |
| 21 | Connection |
| 22 | Connection |
| | interruption |
| 23 | Island computer |
| 26 | Computer with |
| | empty area |
| 27, 28 | Edge computer |
| 29 | Master computer |
| 31, 32 | Island |
| 41, 42 | Cross connection |
| 50 | Area |
| 51 | Arrow symbol |
| 55, 56, 57 | Interruption point |
| 100 | Cable drum |
| 101 | Core |
| 102 | Radio access |
| 103 | OWG terminal |
| 104 | Peripheral |
| | terminal |
| 105 | Optical waveguide |
| | cable |
| 106 | Hub |
| 107 | Power supply |
| A1-A8 | Network computer |
| B1-B8 | Network computer |

1-11. (canceled)

12. A communication network in an underground structure (5), wherein underground network computers are arranged at a number of nodes (20; A1-A8; B1-B8), which network computers are in each case connected to a central system computer unit (6) in a normal case, wherein the network computers (20) are configured to detect an emergency due to loss (22; 55, 56, 57) of the connection to the central system computer unit (6) and then to initiate an emergency mode, characterized in that the communication network is configured in such a manner that, in an emergency, at least one network or application function of the central system computer unit (6) is taken over by at least one of the underground network computers (29) and that at least one application function (51) is activated on at least one of the underground network computers (20, 26, 27, 28, 29) for the emergency, wherein at least one network computer (20; 27; 28; 29) being provided with at least one sensor or being connected with that or via a separate detect unit to receive the environmental information, if necessary to process them, in particular for the activation of a change of status, and to pass them on in the network.

13. The communication network as claimed in claim 12, characterized in that each network computer (20) has an overview of an overall structure or relevant parts of the communication network.

14. The communication network as claimed in claim 12, characterized in that each network computer (20) has one assigned network status from a group of predefined statuses; especially normal operation and emergency operation.

15. The communication network as claimed in claim 12, characterized in that at least one network computer (20; 29) is configured to seek an alternative communication path in the event of a connection interruption between network nodes in order to maintain the communication.

16. The communication network as claimed in claim 12, characterized in that at least one network computer (29) in a network island (31; 32; 50) produced by a connection interruption, is configured to assume a master status as network device of the network island (31; 32; 50) in emergency operation, wherein all other network computers (20) of the network island are configured to assume a slave status in emergency operation.

17. The communication network as claimed in claim 16, characterized in that at least one network computer (29) is configured, said information relating to the environment is made available to all other network computers of the network island in emergency operation and is configured, or to take over network functions of the central system computer unit (6) in the network island produced by the connection interruption.

18. The communication network as claimed in claim 12, characterized in that each network computer (20) within a network island produced by the connection interruption is configured to create, and represent visually or audibly on a display (51), an image of a safety situation via a network status and current environmental information in emergency operation.

19. A method for safety-related communication in an underground structure wherein underground network computers arranged at a number of nodes form in a communication network and are in each case connected to a central system computer unit in a normal operation, wherein at least one network computer detects an emergency due to loss of the connection to the central system computer unit and then initiates an emergency mode, characterized in that at least one network computer takes over at least one network function of the central system computer unit in an emergency and in that at least one application function is activated on at least one of the underground network computers for the emergency, wherein at least one network computer (20; 27; 28; 29) takes up and if necessary process the environmental information with at least one sensor, connected directly or via a separate detect unit, in particular for the activation of a change of status, and to pass it on in the network.

20. The method as claimed in claim 19, wherein the emergency mode is triggered on the basis of at least one item of sensor information and/or status information or manually, especially due to the cutting-off of a predetermined number of network units from the aboveground network.

21. A communication element for setting up provisional connection structures, especially for use with a communication network as claimed in claim 12, characterized in that a communication cable (105) can be rolled up on a cable drum (101), wherein an end of the cable (105) is connected to the cable drum (101) and wherein the hub and the side elements of the cable drum (101) have a connection for at least one further communication cable (105) and an inherent power supply for a control unit built into the cable drum (101) and antenna of a wireless communication unit.
